(19) United States
(12) Patent Application Publication
(10) Pub. No.: US 2016/0245085 A1
(43) Pub. Date: Aug. 25, 2016

(54) ROTATION BODY OF NOZZLE FOR REACTION-TYPE STEAM TURBINE

(71) Applicants: POSCO ENERGY CO., LTD., Seoul (KR); HK TURBINE CO., LTD., Gyeonggi-do (KR)

(72) Inventors: Ju Chang LIM, Incheon (KR); Sung Keun OH, Incheon (KR); Jae Jun LEE, Seoul (KR); Sang Myeong LEE, Seongnam-si, Gyeonggi-do (KR); Sanghoon LEE, Seoul (KR); Ki Tae KIM, Anyang-si, Gyeonggi-do (KR); Young IL CHANG, Anyang-si, Gyeonggi-do (KR); Hyun Joo CHUN, Bucheon-si, Gyeonggi-do (KR); Yong Sik HA, Seoul (KR)

(73) Assignees: POSCO ENERGY CO., LTD., Seoul (KR); HK TURBINE CO., LTD., Anyang-si, Gyeonggi-do (KR)

(21) Appl. No.: 15/025,692

(22) PCT Filed: May 23, 2014
(86) PCT No.: PCT/KR2014/004627

§ 371 Date: Mar. 29, 2016

(30) Foreign Application Priority Data
Sep. 30, 2013 (KR) 10-2013-0115982

(51) Int. Cl. F01D 1/32

(52) U.S. Cl. CPC F01D 1/32; F05D 2220/31; F05D 2240/242; F05D 2240/60; F05D 2250/25

(57) ABSTRACT

Disclosed herein is a nozzle rotation body for a reaction-type steam turbine, the rotation body rotating by ejection of fluid from the nozzle. The rotation body includes: a disk-shaped body (210) having an shaft hole that is formed in the center thereof and coupled to a rotary shaft; a guide portion (220), projected in the vertical direction and integrally formed with the body (210) to have a guide side (GS) providing a plurality of exhaust flow paths (221) forming equal angles to each other in the helical direction around the shaft hole; a nozzle piece (230), positioned on each front end of the exhaust flow paths (221) and assembled with the body (210), to have a cross section of the same shape as the cross section of the exhaust flow paths (221) and have a narrow width section; and a fastening unit having at least one bolt (241) and at least one assembly pin (242) coupling the nozzle piece (230) and the body (210).

### TECHNICAL FIELD

The present invention relates generally to a nozzle rotation body for a reaction-type steam turbine, the rotation body rotating by ejection of a fluid from nozzles.

### BACKGROUND ART

In general, a steam turbine as a prime mover, which uses high pressure steam to do mechanical work, is widely used as a primary engine in a thermoelectric power plant or a vessel.

Examples of this type of a steam turbine include: an impulse type turbine, which only uses an impact force generated by an ejected stream of high pressure steam by ejecting the high pressure steam from a nozzle to blades; and a reaction type turbine, which uses a reaction force generated by changing areas of cross sections between blades in addition to the ejected stream.

Meanwhile, in addition to the general type steam turbines described above, a plurality of reaction-type steam turbines using a reaction generated by steam ejected from a rotation body is known. Further, structures of the reaction-type steam turbines are simple and the reaction-type steam turbines may obtain high thermal efficiency since the reaction-type steam turbines obtain rotation energy generated by reaction of ejected steam energy. Thus, reaction-type steam turbines are appropriate as a small or medium capacity prime mover.

Examples of conventional reaction type turbines are disclosed in Koran Patent Application Publication No. 10-2012-47709 (Published on May 14, 2012), Koran Patent Application Publication No. 10-2013-42250 (Published on Apr. 26, 2013), and Koran Patent No. 10-1229575 (Registered on Jan. 29, 2013).

The reaction type turbines include: a housing having a housing flow path; a turbine shaft rotatably coupled to the housing for transmitting a rotational force; and a plurality of nozzle assembly bodies, coupled to the turbine shaft and rotatably disposed in the housing flow path, to generate a rotational force by ejecting high pressure fluid in a circumferential direction.

A nozzle plate disclosed in Koran Patent Application Publication No. 10-2012-47709 (Published on May 14, 2012) is described below to help understanding of the present invention.

FIG. 1 is a view illustrating a plan configuration of the nozzle plate for a reaction-type steam turbine according to the related art. A nozzle assembly is integrally formed in such a way that a disk-shaped cover having the same size as in the nozzle plate is assembled with an upper portion of the nozzle plate.

Referring to FIG. 1, the nozzle plate 1 according to the related art is configured such that a shaft hole 11 coupled to a rotary shaft (a turbine shaft) is formed on the center of a disk-shaped body 10, and a plurality of ejection communication holes 12 is formed around the shaft hole 11.

The ejection communication holes 12 include: first ejection communication holes 12a communicating with ejection introduction holes of a cover (not shown in the drawings); and second ejection communication holes 12b connecting the first ejection communication holes 12a and ejection outlet holes 13 to each other. The ejection communication holes 12 and the ejection outlet holes 13 are provided as grooves formed in quadrangular shapes (or rectangular shapes) by milling a disk-shaped body having a predetermined thickness.

Nozzles 20 adjacent to the ejection outlet holes 13 are assembled with the body 10 by using bolts or rivets. Reference numeral 23 in the drawing denotes bolt holes for coupling bolts. Nozzle holes 21 are formed through centers of the nozzles 20. Small diameter portions 22 whose diameters decrease are formed on parts of the nozzle holes 21. Meanwhile, the nozzles 20 produced separately from the body 10 prior to being assembled with the body 10 have the nozzle holes formed by drilling the nozzles.

However, in the nozzle plate according to the related art described above, operational efficiency of the steam turbine deteriorates due to pressure drop in a fluid during a process of ejecting a working fluid, which has been introduced into the first ejection communication holes 12a, via the nozzles 20. Further, in a long-term operation of a turbine, the nozzles 20 assembled with the body 10 are exposed to large pressure and impact along with a centrifugal force. Accordingly, the nozzles 20 may be suddenly separated from the body 10, and thus, severe damage of the turbine may occur.

More specifically, the ejection communication holes 12 and the ejection outlet holes 13 of the body 10 are formed by milling, and the nozzle holes of the nozzles are formed by drilling. Thus, cross sections of the ejection communication holes are formed in quadrangular shapes (or rectangular shapes), whereas cross sections of the nozzle holes of the nozzles are formed in circular shapes. Accordingly, steps are inevitably formed between the nozzle holes 21 formed in circular shapes and the ejection outlet holes 13 formed in quadrangular shapes, and the steps greatly disturb flow of fluid, thereby deteriorating operational efficiency of the steam turbine due to pressure drop in fluid.

Further, in the nozzle plate according to the related art described above, the nozzles 20 are located in and fastened to the farthest outer circumferential portion of the body 10, so that bolt coupling portions (bolt holes, region A) of the nozzles 20, which are coupled to the body 10, are supported only from the inside, and the outer circumferential surfaces of the nozzles 20 on which the centrifugal force acts are not supported by the body. Further, bolts are vulnerable to shear stress. Thus, when the nozzles 20 are assembled by using bolts only, the nozzles 20 are exposed to large pressure and impact in addition to the centrifugal force during a long-term operation of the steam turbine. Accordingly, the nozzles 20 may be suddenly separated from the body 10 due to breakages of bolts, and thus, severe damage to the turbine may occur.

### RELATED ART DOCUMENTS

(Patent Document 1) Koran Patent Application Publication No. 10-2012-0047709 (Published on May 14, 2012)

(Patent Document 2) Koran Patent Application Publication No. 10-2013-0042250 (Published on Apr. 26, 2013)

(Patent Document 3) Koran Patent No. 10-1229575 (Registered on Jan. 29, 2013)

### DISCLOSURE

### Technical Problem

Accordingly, the present invention has been made keeping in mind the above problems occurring in the related art, and the present invention is intended to propose a nozzle rotation body for a reaction-type steam turbine (hereinafter referred to simply as “the nozzle rotation body”) in which, pressure drop in a fluid on a flow path is minimized by improving the structure of a nozzle, thereby increasing durability of the nozzle.

### Technical Solution

In order to achieve the above object, according to one aspect of the present invention, there is provided a nozzle rotation body for a reaction-type steam turbine, the rotation body including: a disk-shaped body having a shaft hole formed in a center of the disk-shaped body and coupled to a rotary shaft; guide portions, vertically projected from and integrally formed with the disk-shaped body, to have guide sides providing a plurality of helical exhaust flow paths angularly spaced apart from each other at equal intervals around the shaft hole; nozzle pieces, positioned at front ends of the plurality of helical exhaust flow paths respectively and assembled with the disk-shaped body, to have cross sections formed in same shapes as shapes of cross sections of the plurality of helical exhaust flow paths and define narrow width sections of the plurality of helical exhaust flow paths; and a fastening unit for fastening each of the nozzle pieces to the disk-shaped body, the fastening unit including at least one locking bolt and at least one assembly pin.

According to the present invention, the nozzle pieces may be fastened in outer circumferential portions at the front ends of the plurality of helical exhaust flow paths and face the guide sides of the respective guide portions, and may define the narrow width sections of the plurality of helical exhaust flow paths in cooperation with the guide sides of the respective guide portions.

According to the present invention, the guide portions may further include: escape prevention supports supporting outer circumferential surfaces of the nozzle pieces against radial directions of the disk-shaped body.

According to the present invention, the cross sections of the plurality of helical exhaust flow paths may be formed in quadrangular shapes. More preferably, the corners of the plurality of helical exhaust flow paths are formed in curved shapes.

According to the present invention, hollow cavities may be formed inside the guide sides of the guide portions.

### Advantageous Effects

A nozzle rotation body for a reaction-type steam turbine according to the present invention is advantageous in that capacity of a turbine can be easily changed by replacing a nozzle piece constituting a nozzle in a body, the structure of the nozzle can be improved so as to minimize pressure drop due to fluid resistance, and durability of the nozzle can be increased.

### DESCRIPTION OF DRAWINGS

FIG. 1 is a view illustrating a plan configuration of a nozzle plate for a reaction-type steam turbine according to the related art;

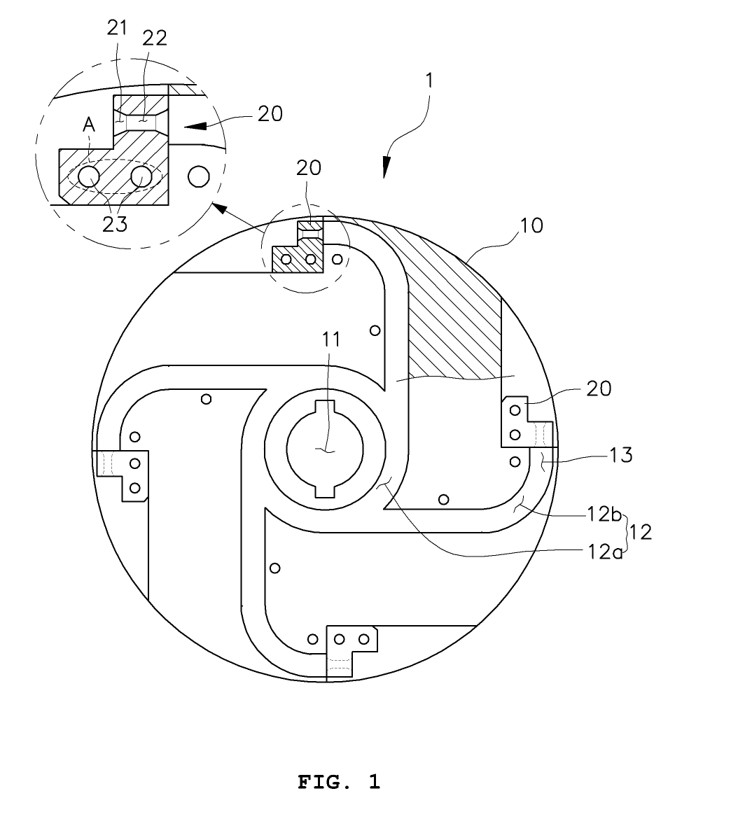

FIG. 2 is a plan view of a nozzle rotation body for a reaction-type steam turbine according to a first embodiment of the present invention;

FIG. 3 is a perspective view of the nozzle rotation body for a reaction-type steam turbine according to the first embodiment of the present invention;

FIGS. 4a, 4b, 4c, and 4d are views illustrating sectional configurations taken along lines A-A and B-B of FIG. 2;

FIG. 5 is a plan view of a nozzle rotation body for a reaction-type steam turbine according to a second embodiment of the present invention; and

FIG. 6 is a sectional view taken along line C-C of FIG. 5.

### DESCRIPTION OF THE REFERENCE NUMERALS IN THE DRAWINGS

| | |
|---|---|
| 100, 200: nozzle rotation body | |
| 110, 210: body | 111: shaft hole |
| 120, 220: guide portion | |
| 121, 221: exhaust flow path | |
| 122: escape prevention support | |
| 130, 230: nozzle piece | GS: guide side |

### MODE FOR INVENTION

Specific structural and functional descriptions of embodiments of the present invention disclosed herein are only for illustrative purposes of the embodiments of the present invention. The embodiments according to the spirit and scope of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to”, or “directly adjacent to” should be construed in the same way.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinbelow, embodiments of the present invention are described in detail with reference to the accompanying drawings as follows.

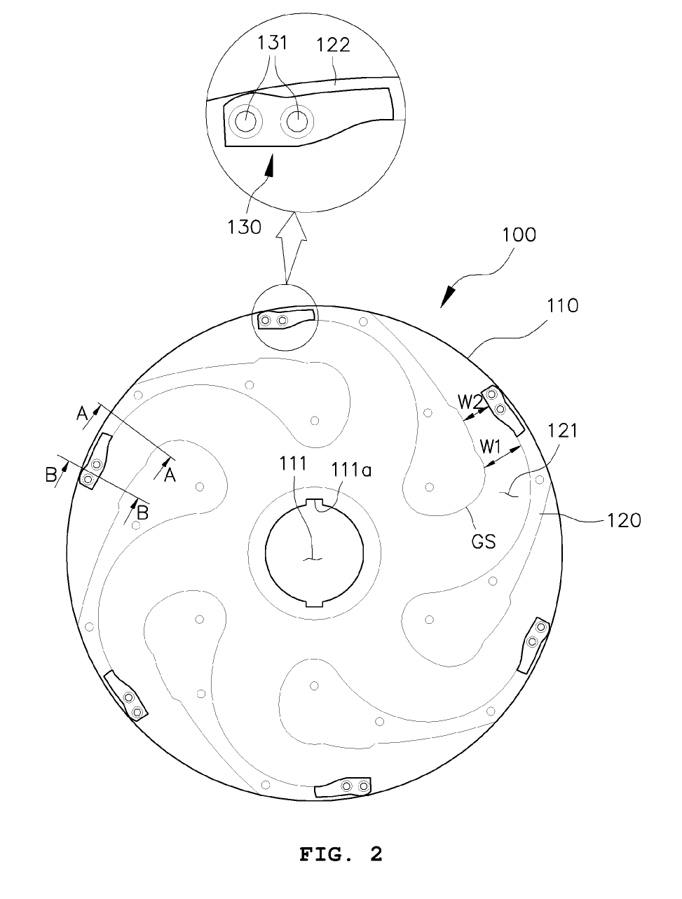

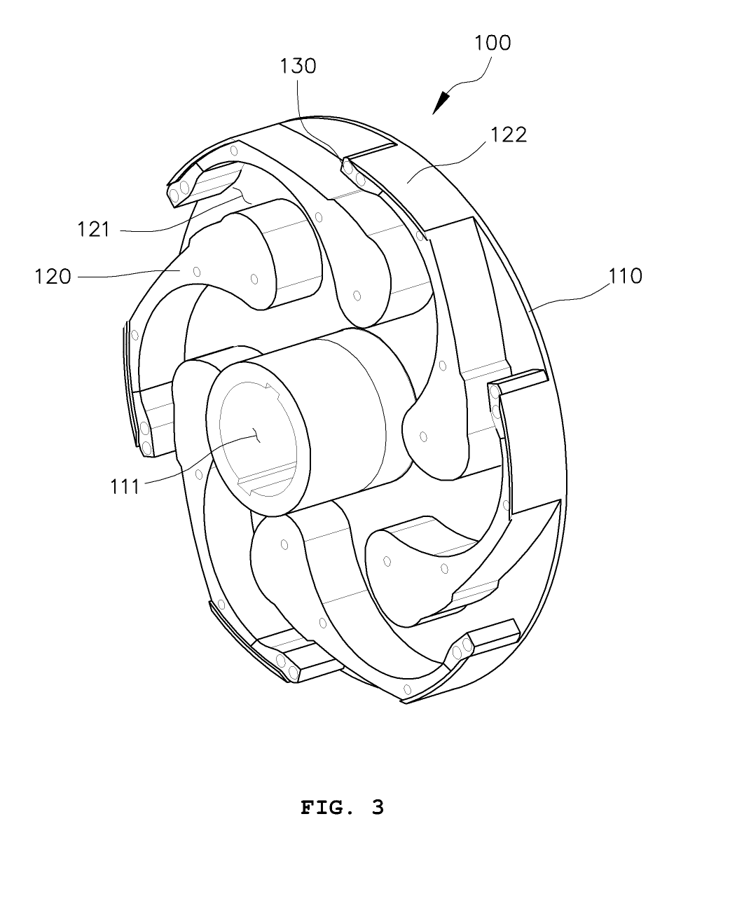

FIG. 2 is a plan view of a nozzle rotation body for a reaction-type steam turbine according to the present invention. FIG. 3 is a perspective view of the nozzle rotation body for a reaction-type steam turbine according to the present invention.

Referring to FIGS. 2 and 3, the nozzle rotation body 100 according to the present invention includes: a disk-shaped body 110; guide portions 120, vertically projected from and integrally formed with the body 110, to provide a plurality of exhaust flow paths 121 having flow path guide sides GS; and nozzle pieces 130 positioned at front ends of the exhaust flow paths 121 respectively and assembled with the body 110 by using fastening units.

The body 110 is formed in a disk shape having a predetermined thickness and is configured to have a shaft hole 111 formed in a center of the body. Further, the guide portions 120 providing the plurality of exhaust flow paths 121 around the shaft hole 111 are projected from and integrally formed with the body 110. Preferably, the guide portions 120 are configured such that the exhaust flow paths 121 are provided by the guide sides GS of grooves formed on a disk-shaped base material for the disk-shaped body 110 by milling the disk-shaped base material.

A key way 111a being coupled to a rotary shaft (a turbine shaft) may be formed on an inner circumferential surface of the shaft hole 111.

The plurality of exhaust flow paths 121 are angularly spaced apart from each other at equal intervals around the shaft hole 111 and are formed in helical shapes. Further, the nozzle pieces 130 are assembled at first sides of front ends of the exhaust flow paths 121 respectively by using the fastening units.

In the present embodiment according to the present invention, the nozzle pieces 130 are fastened in outer circumferential portions at the front ends of the exhaust flow paths 121 and face the guide sides GS of the respective guide portions 120, and define narrow width sections (W1>W2) of the exhaust flow paths 121 in cooperation with the guide sides GS of the respective guide portions 120. Accordingly, ejection speed of fluid ejected from the exhaust flow paths having narrow cross sections may be increased.

The nozzle pieces 130 have coupling holes 131, and may be assembled with the body 110 by using fastening units, such as a bolt or rivet.

As described above, the nozzle pieces 130 assembled with the body 110 by using the fastening units may be easily replaced. Thus, capacity of a turbine may be easily changed by changing widths of the exhaust flow paths in such a way that only the nozzle pieces 130 are replaced at the turbine.

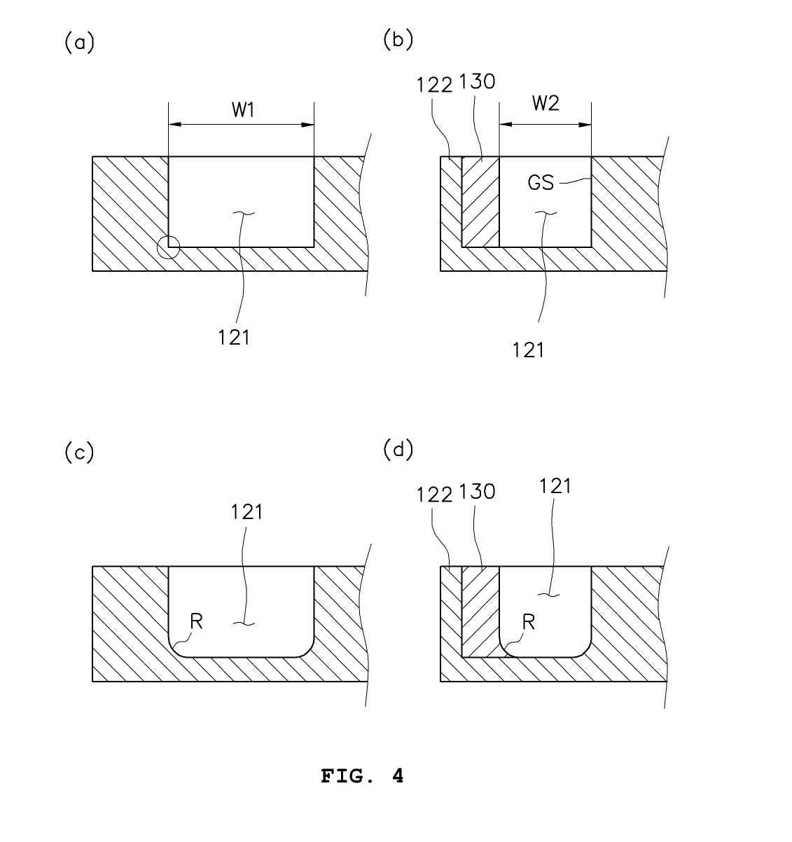

FIGS. 4a and 4b are views illustrating sectional configurations taken along lines A-A and B-B of FIG. 2 respectively. Further, FIGS. 4c and 4d are views illustrating other embodiments of FIGS. 4a and 4b respectively.

As shown in FIG. 4a, the exhaust flow paths 121 have cross sections formed in quadrangular shapes (or rectangular shapes). Meanwhile, as shown in FIG. 4b, the exhaust flow paths 121 formed in quadrangular shapes (or rectangular shapes) are provided by the nozzle pieces 130 fastened in the outer circumferential portions at the front ends of the exhaust flow paths and the guide sides GS facing the nozzle pieces 130. Thus, resistance of fluid ejected along the exhaust flow paths 121 may be minimally decreased.

Meanwhile, as shown in FIGS. 4c and 4d, bottom corners of the exhaust flow paths 121 may be formed in curved shapes rather than right-angled shapes.

Referring back to FIGS. 2 and 3, the guide portions 120 may further include escape prevention supports 122 coming into contact with outer circumferential surfaces of the nozzle pieces 130.

When the nozzle rotation body rotates, the escape prevention supports 122 may prevent the nozzle pieces 130 from escaping from the body by supporting the nozzle pieces 130 against a centrifugal force of nozzle pieces 130 which acts in radial directions of the body.

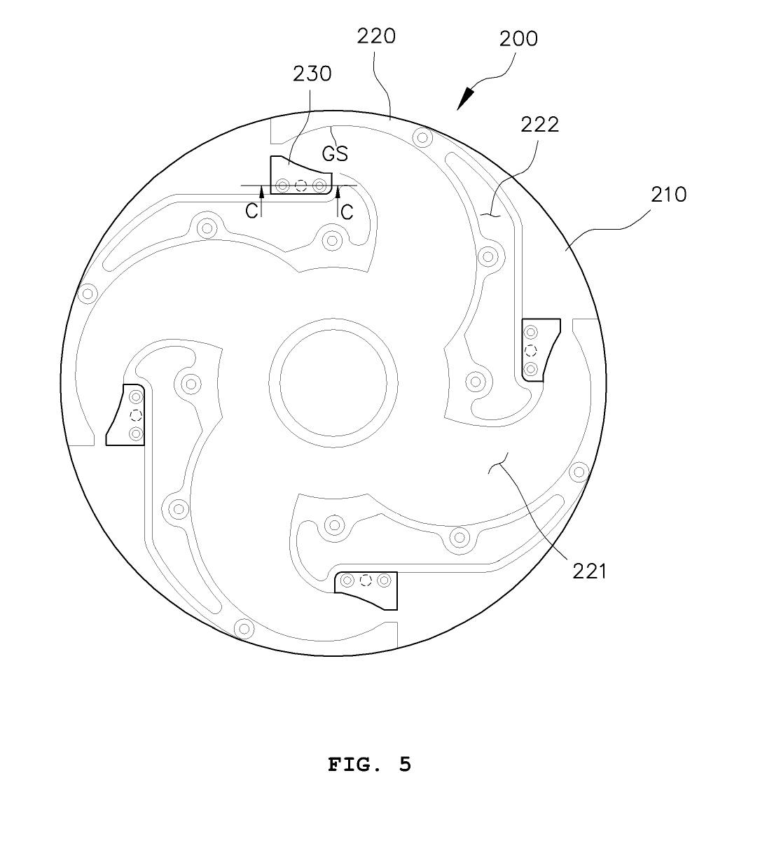

FIG. 5 is a plan view of a nozzle rotation body for a reaction-type steam turbine according to a second embodiment of the present invention.

As shown in FIG. 5, the nozzle rotation body 200 according to the present embodiment of the present invention includes: a disk-shaped body 210; guide portions 220 integrally formed with the body 210, to provide a plurality of exhaust flow paths 221; and nozzle pieces 230, positioned at front ends of the exhaust flow paths 221 respectively and assembled with the body 210. In this case, the nozzle rotation body 200 according to the present embodiment of the present invention is substantially the same as the foregoing described embodiment (with reference to FIGS. 2 and 3) and is described below by focusing on the differences therebetween.

In the present embodiment, the nozzle pieces 230 are fastened in inner circumferential portions at the front ends of the respective exhaust flow paths 221 and face the guide sides GS of the respective guide portions 220, and define narrow width sections of the exhaust flow paths in cooperation with the guide sides of the respective guide portions, thereby ejecting fluid.

Preferably, the nozzle rotation body 200 becomes lightweight by forming hollow cavities 222 inside the guide portions 220. Thus, starting time of a turbine is decreased, and friction loss of a bearing for supporting the shaft of the rotation body is decreased, thereby improving efficiency of the turbine.

Especially, in the present embodiment, each of the nozzle pieces 230 is fastened to the body 210 by using a fastening unit including at least one locking bolt and at least one assembly pin.

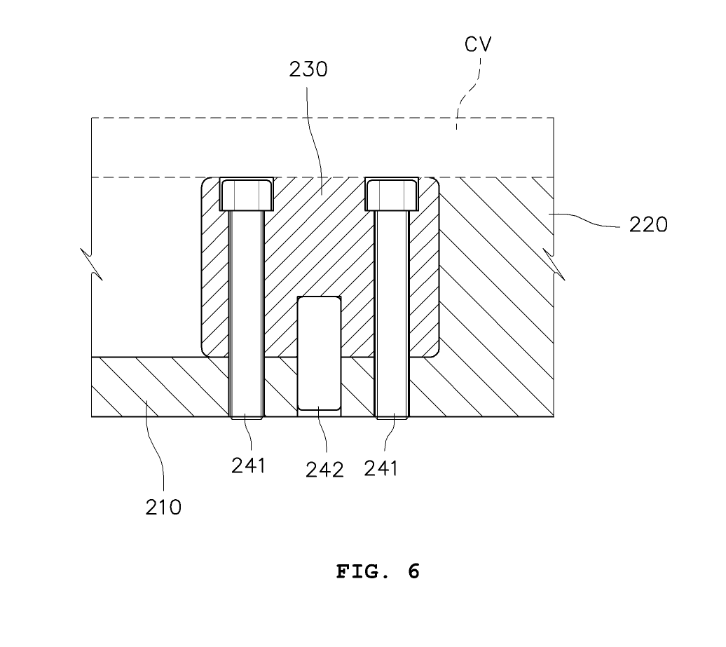

As shown in FIG. 6, each of the nozzle pieces 230 is assembled with the body 210 by using two locking bolts 241 and one assembly pin 242 in such a way that first surfaces of the nozzle pieces 230 come into contact with the guide portions 220.

Since the assembly pin 242 supports a larger amount of shear stress than the bolt 241, the nozzle pieces 230 may be more securely fastened by using the assembly pin in addition to the bolt compared to using only the bolt even when a large impact load is applied to the nozzle pieces 230.

Reference character ‘CV’ in the drawings means a cover forming the nozzle assembly in such a way that the cover is coupled to the nozzle rotation body.

Although the present invention is described with reference to the above described embodiments and the accompanying drawings, the present invention, however, is not limited thereto, and those skilled in the art will clearly appreciate that various modifications, additions and substitutions are possible without departing from the scope and spirit of the present invention as disclosed in the accompanying claims.

1. A nozzle rotation body for a reaction-type steam turbine, the rotation body comprising:
a disk-shaped body having a shaft hole formed in a center of the disk-shaped body and coupled to a rotary shaft;
guide portions, vertically projected from and integrally formed with the disk-shaped body, to have guide sides providing a plurality of helical exhaust flow paths angularly spaced apart from each other at equal intervals around the shaft hole;
nozzle pieces, positioned at front ends of the plurality of helical exhaust flow paths respectively and assembled with the disk-shaped body, to have cross sections formed in same shapes as shapes of cross sections of the plurality of helical exhaust flow paths and define narrow width sections of the plurality of helical exhaust flow paths; and
a fastening unit for fastening each of the nozzle pieces to the disk-shaped body, the fastening unit including at least one locking bolt and at least one assembly pin.

2. The nozzle rotation body of claim 1, wherein the nozzle pieces are fastened in outer circumferential portions at the front ends of the plurality of helical exhaust flow paths and face the guide sides of the respective guide portions, and define the narrow width sections of the plurality of helical exhaust flow paths in cooperation with the guide sides of the respective guide portions.

3. The nozzle rotation body of claim 1, wherein the guide portions further comprise: escape prevention supports supporting outer circumferential surfaces of the nozzle pieces against radial directions of the disk-shaped body.

4. The nozzle rotation body of claim 1, wherein the cross sections of the plurality of helical exhaust flow paths are formed in quadrangular shapes.

5. The nozzle rotation body of claim 4, wherein corners of the plurality of helical exhaust flow paths are formed in curved shapes.

6. The nozzle rotation body of claim 1, wherein hollow cavities are formed inside the guide sides of the guide portions.

7. The nozzle rotation body of claim 2, wherein the guide portions further comprise: escape prevention supports supporting outer circumferential surfaces of the nozzle pieces against radial directions of the disk-shaped body.
